(19) United States
(12) Patent Application Publication
(10) Pub. No.: US 2023/0163997 A1
(43) Pub. Date: May 25, 2023

(54) LOGICAL OVERLAY TUNNEL SELECTION

(71) Applicant: VMware, Inc., Palo Alto, CA (US)

(72) Inventors: Stephen SAUER, Bar le duc (FR); Benoit SARDA, Les Mureaux (FR); Dominic FOLEY, Brentwood (GB); Yann SIMONET, Alfortville (FR)

(73) Assignee: VMware, Inc., Palo Alto, CA (US)

(21) Appl. No.: 17/535,592

(22) Filed: Nov. 25, 2021

(51) Int. Cl. H04L 12/46; H04L 45/00; H04L 45/12; H04L 45/64

(52) U.S. Cl. CPC H04L 12/4633; H04L 45/26; H04L 45/124; H04L 45/64

(57) ABSTRACT

Example methods and systems for logical overlay tunnel selection are described. One example may involve a first computer system generating and sending probe packets over multiple logical overlay tunnels and configuring routing information associated with a destination based on a comparison between tunnel state information measured using the probe packets and a desired state. In response to detecting an egress packet that is destined for the destination, the first computer system may select a first logical overlay tunnel that satisfies the desired state over a second logical overlay tunnel that does not satisfy the desired state. An encapsulated packet is then generated and sent over the first logical overlay tunnel to reach the destination. The encapsulated packet may include the egress packet and an outer header that is addressed from a first virtual tunnel endpoint (VTEP) on the first computer system and a second VTEP on a second computer system.

### BACKGROUND

Virtualization allows the abstraction and pooling of hardware resources to support virtual machines in a Software-Defined Networking (SDN) environment, such as a Software-Defined Data Center (SDDC). For example, through server virtualization, virtualization computing instances such as virtual machines (VMs) running different operating systems may be supported by the same physical machine (e.g., referred to as a “host”). Each VM is generally provisioned with virtual resources to run an operating system and applications. The virtual resources may include central processing unit (CPU) resources, memory resources, storage resources, network resources, etc. In practice, a logical overlay tunnel may be established between a pair of virtual tunnel endpoints (VTEPs) to facilitate traffic forwarding. However, traffic over logical overlay tunnels may be susceptible to various performance issues that affect the quality of packet flows in the SDN environment.

### BRIEF DESCRIPTION OF DRAWINGS

FIG. 1 is a schematic diagram illustrating an example software-defined networking (SDN) environment in which logical overlay tunnel selection may be performed;

FIG. 2 is a schematic diagram illustrating an example physical view of hosts in an SDN environment;

FIG. 3 is a flowchart of an example process for a first computer system to perform logical overlay tunnel selection;

FIG. 4 is a flowchart of an example detailed process for a first computer system to perform logical overlay tunnel selection;

FIG. 5 is a schematic diagram illustrating an example of logical overlay tunnel monitoring and routing information configuration;

FIG. 6 is a schematic diagram illustrating an example of logical overlay tunnel selection for the example in FIG. 5;

FIG. 7 is a schematic diagram illustrating an example of logical overlay tunnel selection in the event of performance degradation for the example in FIG. 5; and

FIG. 8 is a schematic diagram illustrating an example of logical overlay tunnel selection for a first computer system with multiple virtual tunnel endpoints (VTEPs).

### DETAILED DESCRIPTION

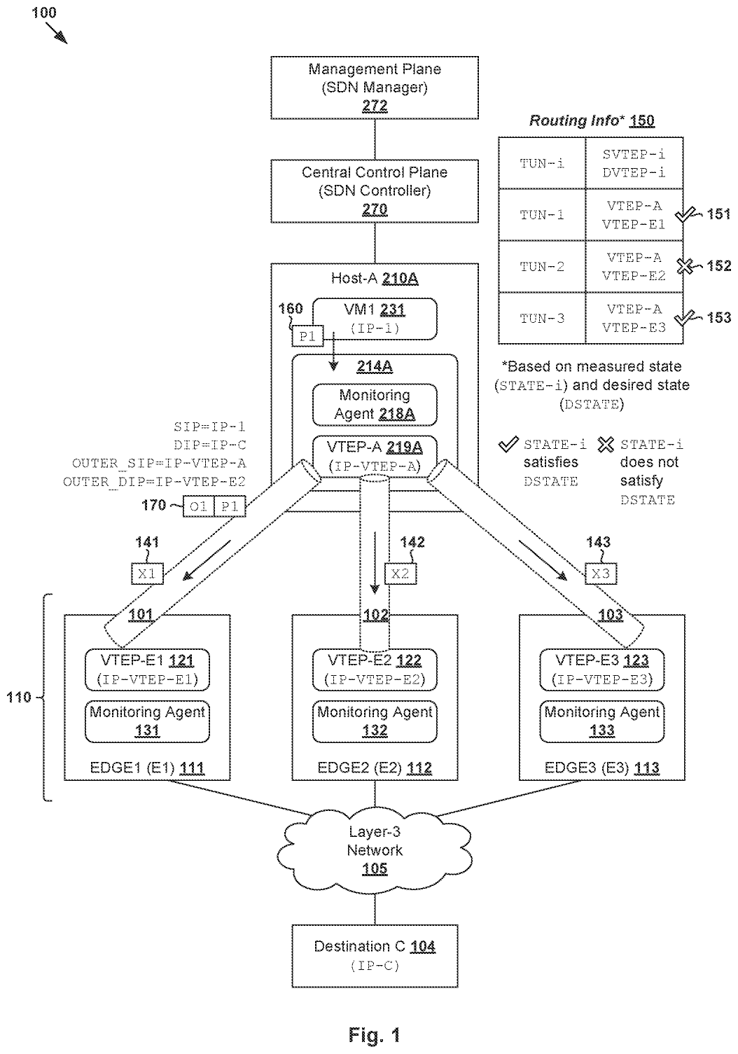

According to examples of the present disclosure, logical overlay tunnel selection may be implemented more dynamically based on tunnel state information. One example may involve a first computer system (e.g., host-A 210A in FIG. 1) generating and sending probe packets over multiple logical overlay tunnels (e.g., 101-103 in FIG. 1) and configuring routing information associated with a destination based on a comparison between (a) tunnel state information measured using the probe packets and (b) a desired state. In response to detecting an egress packet that is destined for the destination, the first computer system may select a first logical overlay tunnel that satisfies the desired state over a second logical overlay tunnel that does not satisfy the desired state. An encapsulated packet is then generated and sent over the first logical overlay tunnel to reach the destination. The encapsulated packet may include the egress packet and an outer header that is addressed from a first virtual tunnel endpoint (VTEP) on the first computer system and a second VTEP on a second computer system (e.g., EDGE 111/112/113 in FIG. 1).

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

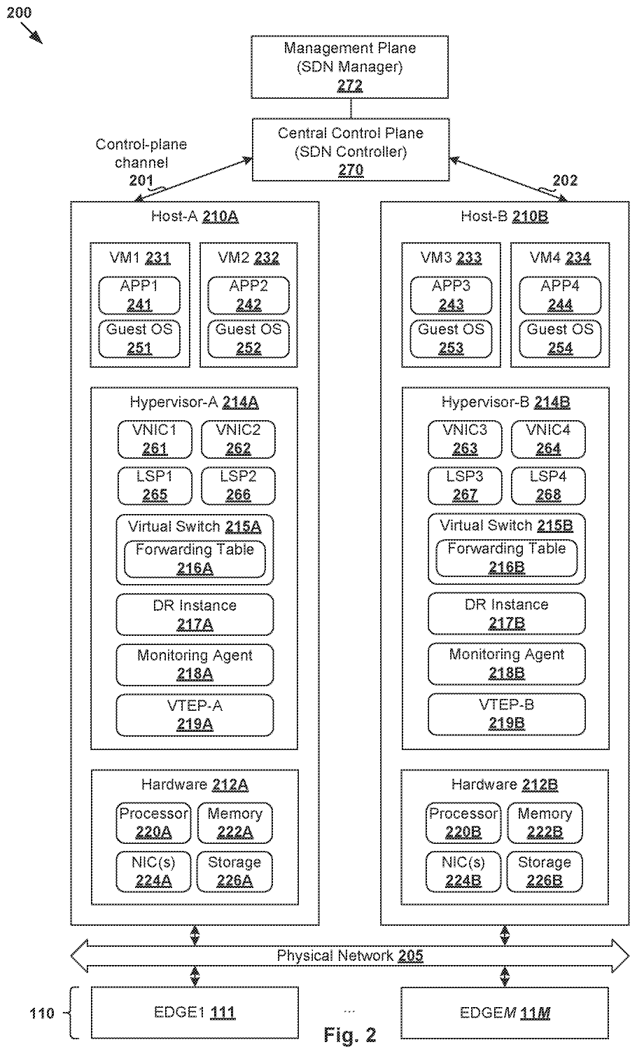

FIG. 1 is a schematic diagram illustrating example software-defined networking (SDN) environment 100 in which logical overlay tunnel selection may be performed. FIG. 2 is a schematic diagram illustrating example physical view 200 of hosts in SDN environment 100. It should be understood that, depending on the desired implementation, SDN environment 100 may include additional and/or alternative components than that shown in FIG. 1 and FIG. 2. In practice, SDN environment 100 may include any number of hosts (also known as “computer systems,” “computing devices”, “host computers”, “host devices”, “physical servers”, “server systems”, “transport nodes,” etc.).

In the example in FIG. 1, SDN environment 100 may include host-A 210A (“first computer system”) and a cluster of multiple EDGE nodes 101-103 (“second computer systems”) that are connected with remote destination 104 via physical network 105. In practice, an EDGE node (or more simply “EDGE”) may be deployed at the edge of a data center site to provide north-south connectivity to virtual machines (VMs) such as VM1 231 supported by host-A 210A. To facilitate traffic forwarding, multiple (N) logical overlay tunnels (e.g., 101-103) are established between host 210A and respective EDGE nodes 101-103. As such, host-A 210A may select one of multiple logical overlay tunnels 101-103 to reach remote destination 104. Each tunnel (denoted as TUN-i, where i=1, . . . , N) represents a path in multipath routing to destination 104.

Referring also to FIG. 2, SDN environment 100 may include host-A 210A in FIG. 1 as well as other hosts, such as host 210B. Host 210A/210B may include suitable hardware 212A/212B and virtualization software (e.g., hypervisor-A 214A, hypervisor-B 214B) to support various VMs. For example, host-A 210A may support VM1 231 and VM2 232, while VM3 233 and VM4 234 are supported by host-B 210B. Hardware 212A/212B includes suitable physical components, such as central processing unit(s) (CPU(s)) or processor(s) 220A/220B; memory 222A/222B; physical network interface controllers (PNICs) 224A/224B; and storage disk(s) 226A/226B, etc.

Hypervisor 214A/214B maintains a mapping between underlying hardware 212A/212B and virtual resources allocated to respective VMs. Virtual resources are allocated to respective VMs 231-234 to support a guest operating system (OS; not shown for simplicity) and application(s); see 241-244, 251-254. For example, the virtual resources may include virtual CPU, guest physical memory, virtual disk, virtual network interface controller (VNIC), etc. Hardware resources may be emulated using virtual machine monitors (VMMs). For example in FIG. 2, VNICs 261-264 are virtual network adapters for VMs 231-234, respectively, and are emulated by corresponding VMMs (not shown) instantiated by their respective hypervisor at respective host-A 210A and host-B 210B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 214A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” a network or Internet Protocol (IP) layer; and “layer-4” a transport layer (e.g., using Transmission Control Protocol (TCP), User Datagram Protocol (UDP), etc.), in the Open System Interconnection (OSI) model, although the concepts described herein may be used with other networking models.

SDN controller 270 and SDN manager 272 are example network management entities in SDN environment 100. One example of an SDN controller is the NSX controller component of VMware NSX® (available from VMware, Inc.) that operates on a central control plane. SDN controller 270 may be a member of a controller cluster (not shown for simplicity) that is configurable using SDN manager 272. Network management entity 270/272 may be implemented using physical machine(s), VM(s), or both. To send or receive control information, a local control plane (LCP) agent (not shown) on host 210A/210B may interact with SDN controller 270 via control-plane channel 201/202.

Through virtualization of networking services in SDN environment 100, logical networks (also referred to as overlay networks or logical overlay networks) may be provisioned, changed, stored, deleted and restored programmatically without having to reconfigure the underlying physical hardware architecture. Hypervisor 214A/214B implements virtual switch 215A/215B and logical distributed router (DR) instance 217A/217B to handle egress packets from, and ingress packets to, VMs 231-234. In SDN environment 100, logical switches and logical DRs may be implemented in a distributed manner and can span multiple hosts.

For example, a logical switch (LS) may be deployed to provide logical layer-2 connectivity (i.e., an overlay network) to VMs 231-234. A logical switch may be implemented collectively by virtual switches 215A-B and represented internally using forwarding tables 216A-B at respective virtual switches 215A-B. Forwarding tables 216A-B may each include entries that collectively implement the respective logical switches. Further, logical DRs that provide logical layer-3 connectivity may be implemented collectively by DR instances 217A-B and represented internally using routing tables (not shown) at respective DR instances 217A-B. Each routing table may include entries that collectively implement the respective logical DRs.

Packets may be received from, or sent to, each VM via an associated logical port. For example, logical switch ports 265-268 (labelled “LSP1” to “LSP4”) are associated with respective VMs 231-234. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 215A-B, whereas a “virtual switch” may refer generally to a software switch or software implementation of a physical switch. In practice, there is usually a one-to-one mapping between a logical port on a logical switch and a virtual port on virtual switch 215A/215B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual eXtensible Local Area Network (VXLAN), Stateless Transport Tunneling (STT), Generic Network Virtualization Encapsulation (GENEVE), Generic Routing Encapsulation (GRE), etc. For example, VXLAN is a layer-2 overlay scheme on a layer-3 network that uses tunnel encapsulation to extend layer-2 segments across multiple hosts which may reside on different layer 2 physical networks. Hypervisor 214A/214B may implement virtual tunnel endpoint (VTEP) 219A/219B to encapsulate and decapsulate packets with an outer header (also known as a tunnel header) identifying the relevant logical overlay network (e.g., VNI). Hosts 210A-B may maintain data-plane connectivity with each other via physical network 205 to facilitate east-west communication among VMs 231-234.

Hosts 210A-B may also maintain data-plane connectivity with cluster 110 of multiple (M) EDGE nodes 111-11M in FIG. 2 via physical network 205 to facilitate north-south traffic forwarding, such as between a VM (e.g., VM1 231) and remote destination 104 at a different geographical site. Various examples for the case of M=3 will be described throughout the present disclosure. In practice, each EDGE node may be an entity that is implemented using one or more virtual machines (VMs) and/or physical machines (known as “bare metal machines”) and capable of performing functionalities of a switch, router, bridge, gateway, edge appliance, etc. Each EDGE node may implement a logical service router (SR) to provide networking services, such as gateway service, domain name system (DNS) forwarding, IP address assignment using dynamic host configuration protocol (DHCP), source network address translation (SNAT), destination NAT (DNAT), deep packet inspection, etc. When acting as a gateway, an EDGE node may be considered to be an exit point to an external network.

In the example in FIG. 1, host-A 210A may select one of logical overlay tunnels 101-103 to reach remote destination 104. Conventionally, one approach is to calculate a hash value using packet flow information, such as MAC address information, IP address information, layer-4 port information, or any combination thereof. The hash value is then used to map or assign a particular packet flow to one of logical overlay tunnels 101-103. Over time, the hash-based approach generally works well to load balance traffic among tunnels 101-103 and associated EDGE nodes 111-113.

In practice, however, logical overlay tunnels 101-103 may be susceptible to various performance issues. At one point in time, one tunnel may have better performance than another. For example, a tunnel that is selected using the hash-based approach may have high latency that affects the quality of packet flows. As a result, in some cases, a data center service provider may be unable to fulfil a service level agreement (SLA) signed with a data center customer, which is undesirable.

Logical Overlay Tunnel Selection

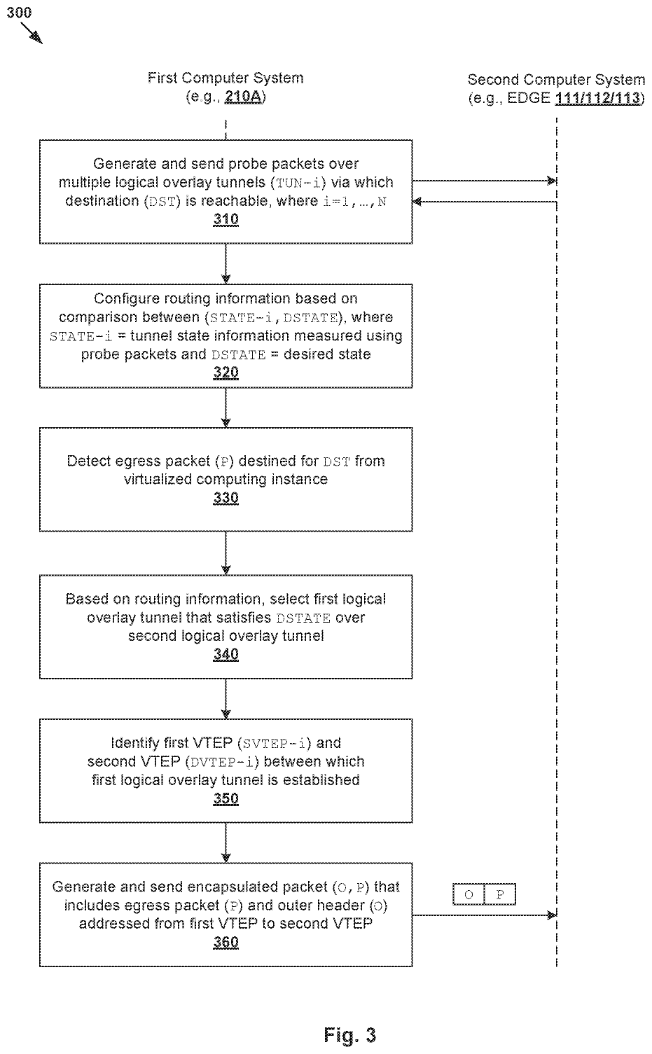

According to examples of the present disclosure, logical overlay tunnel selection may be implemented more dynamically based on tunnel state information that is measured in real time. Some examples will be described using FIG. 3, which is a flowchart of example process 300 for a first computer system to perform logical overlay tunnel selection. Example process 300 may include one or more operations, functions, or actions illustrated by one or more blocks, such as 310 to 360. Depending on the desired implementation, various blocks may be combined into fewer blocks, divided into additional blocks, and/or eliminated. Examples of the present disclosure may be implemented using any suitable “first computer system” (e.g., host-A 210A using agent 218A and VTEP-A 219A), “second computer system” (e.g., EDGE 111/112/113 using agent 131/132/133 and VTEP 121/122/123) and “management entity” (e.g., SDN controller 270 and/or SDN manager 272).

At 310 in FIG. 3, host-A 210A may generate and send probe packets (see 141-143 in FIG. 1) over multiple logical overlay tunnels 101-103 via which destination 104 is reachable from host-A 210A. In the example in FIG. 1, first probe packet 141 is sent from source VTEP-A 219A towards destination VTEP-E1 121 on EDGE1 111 over first tunnel (denoted as TUN-1) 101. Second probe packet 142 is sent towards VTEP-E2 122 on EDGE2 112 over second tunnel (TUN-2) 102. Third probe packet is sent towards destination VTEP-E3 123 on EDGE3 113 over third tunnel (TUN-3) 103.

At 320 in FIG. 3, host-A 210A may configure routing information (see 150 in FIG. 1) associated with destination 104. The configuration may be performed based on a comparison between (a) tunnel state information (denoted as STATE-i) measured using probe packets 141-143 and (b) a desired state (denoted as DSTATE). As used herein, the term “tunnel state information” may refer generally to any suitable network characteristic(s) or metric(s) that may be used to measure the performance of a logical overlay tunnel. Example tunnel state information may include one-way latency, two-way latency, jitter, packet loss, connectivity status, any combination thereof, etc.

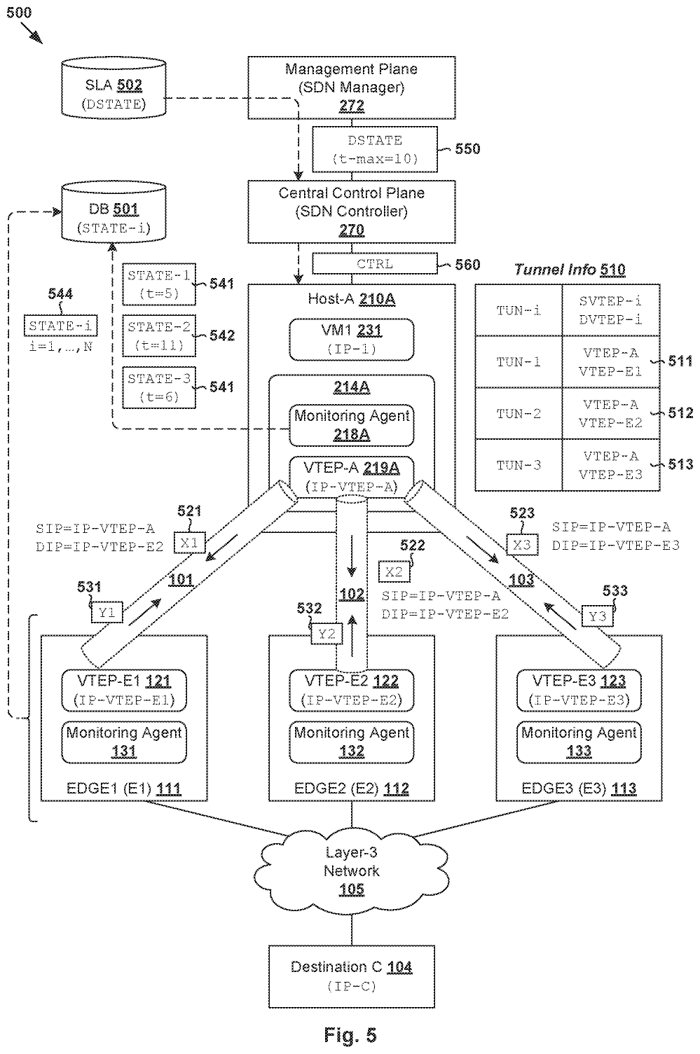

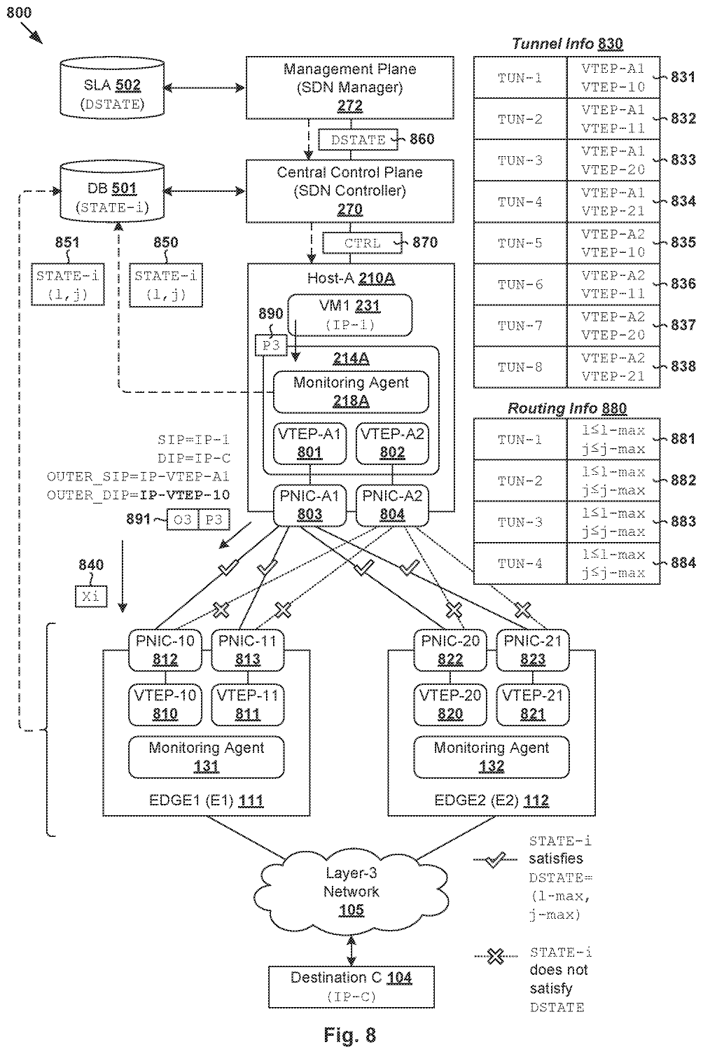

The term “desired state” may include a target performance level or threshold for a particular network characteristic or metric. For example, the desired state may specify one threshold (e.g., maximum latency in FIGS. 5-7), or a combination of thresholds (e.g., maximum packet loss and maximum jitter in FIG. 8). SDN controller 270 may derive or identify the desired state based on service level agreement (SLA) information obtained from the management plane (SDN manager 272), etc. In this case, host-A 210A may configure routing information 150 in response to receiving control information from SDN controller 270 that is capable of identifying the desired state and/or performing the comparison between (a) the tunnel state information and (b) the desired state at 320 in FIG. 3.

At 330-340 in FIG. 3, in response to receiving an egress inner packet (see “P1” 160 in FIG. 1) from VM1 231 to destination 104, logical overlay tunnel selection may be performed based on the routing information. In particular, host-A 210A may select a first logical overlay tunnel (e.g., first tunnel 101 with EDGE1 111) that satisfies the desired state over a second logical overlay tunnel (e.g., second tunnel 102 with EDGE2 112) that does not satisfy the desired state. See also 151-153 in FIG. 1 where routing information 150 indicates that first tunnel 101 and third tunnel 103 satisfies the desired state, but second tunnel 102 does not.

At 350-360 in FIG. 3, host-A 210A may generate and send an encapsulated packet (see 170 in FIG. 1) over the first logical overlay tunnel to reach destination 104. For example in FIG. 1, selected first tunnel 101 is established between first VTEP=VTEP-A 219A on host-A 210A and a second VTEP=VTEP-E1 121 on EDGE 111. In this case, encapsulated packet 170 may include egress packet (P1) 160 and an outer header (O1) addressed from VTEP-A 219A to VTEP-E1 121.

Using examples of the present disclosure, logical overlay tunnel selection may better adapt to varying network characteristics. Unlike conventional hash-based approaches that are agnostic to network conditions, tunnel state information may be measured in real time to improve logical overlay tunnel selection to achieve better packet flow quality and VM performance. Since the desired state may be derived based on SLA(s) between a data center service provider and a service customer, examples of the present disclosure may be implemented to improve the likelihood of SLA fulfilment during overlay network traffic forwarding in SDN environment 100.

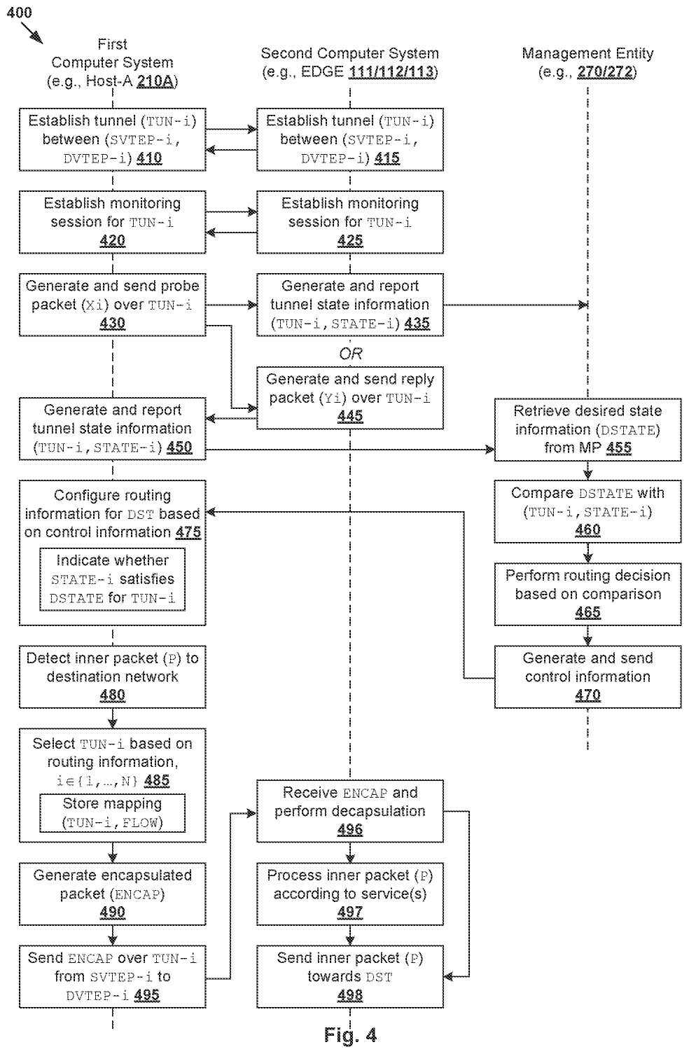

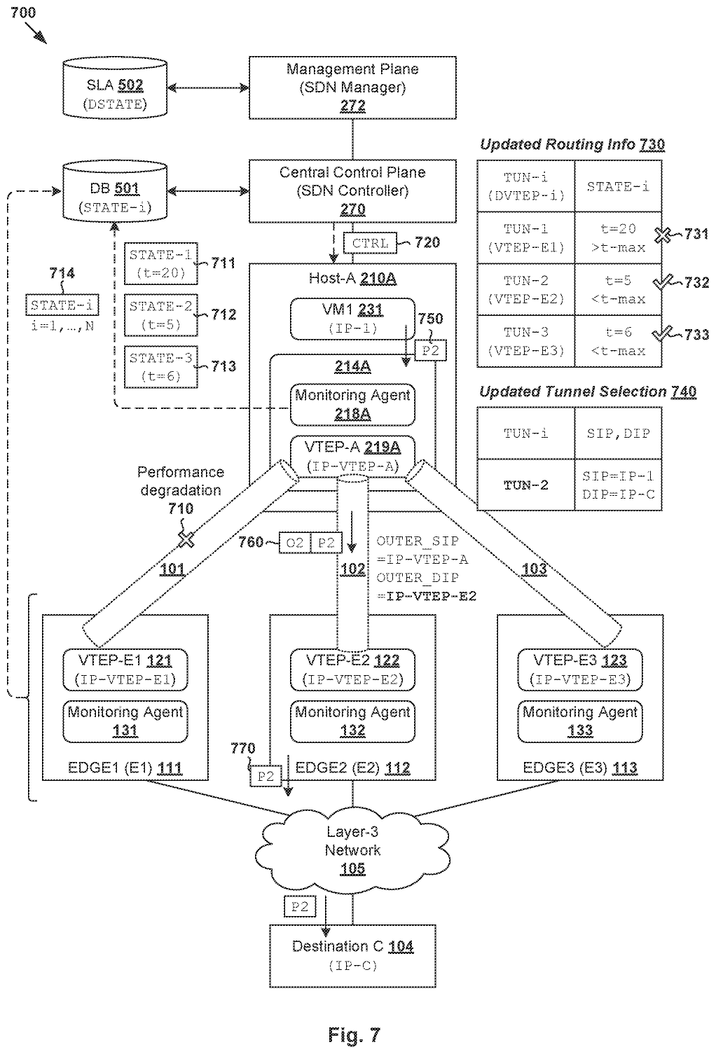

Further, as will be described using FIG. 7 below, routing information 150 in FIG. 1 may be reconfigured based on performance degradation detected using subsequent probe packets. For example, host-A 210A may reconfigure routing information 150 to indicate that first tunnel 101 no longer satisfies the desired state and suffers from performance degradation. In this case, in response to detecting a subsequent egress packet from VM1 231 to destination 104, host-A 210A may switch from first tunnel 101 to another tunnel (e.g., second tunnel 102 with EDGE2 112 or third tunnel 103 with EDGE3 113) that satisfies the desired state. Various examples will be discussed using FIGS. 4-8 below.

Logical Overlay Tunnel Monitoring

FIG. 4 is a flowchart of example detailed process 400 for a first computer system to perform logical overlay tunnel selection. Example process 400 may include one or more operations, functions, or actions illustrated by one or more blocks, such as 410 to 498. Depending on the desired implementation, various blocks may be combined into fewer blocks, divided into additional blocks, and/or eliminated. Some examples will be described using FIG. 5, which is a schematic diagram illustrating example 500 logical overlay tunnel monitoring and routing information configuration. The following notations will be used below: SIP=source IP address, DIP=destination IP address, OUTER_SIP=outer source VTEP IP address in an outer header, OUTER_DIP=outer destination VTEP IP address in the outer header, etc.

(a) Logical Overlay Tunnels

At 410-415 in FIG. 4, host 210A may establish multiple (N) logical overlay tunnels 101-103 (denoted as TUN-i for i=1, . . . , N) with respective EDGE nodes 111-113 to facilitate logical overlay network traffic forwarding. As used herein, the term “logical overlay tunnel” may refer generally to a logical connection or link that is established between a pair of VTEPs. Logical overlay tunnels 101-103 may be established using any suitable tunneling protocol or encapsulation mechanism, such as VXLAN, GENEVE, GRE, etc. The encapsulation mechanisms are generally connectionless. Using GENENE as an example, various implementation details may be found in a draft document entitled “GENEVE: Generic Network Virtualization Encapsulation” (draft-ietf-nvo3-geneve-16) published by Internet Engineering Task Force (IETF). The document is incorporated herein by reference.

In the example in FIG. 5, VTEP-A 219A on host-A 210A may represent a source VTEP (denoted as SVTEP-i) and VTEP 121/122/123 on EDGE 111/112/113 a destination VTEP (denoted as DVTEP-i). First tunnel 101 may be established between (SVTEP-1=VTEP-A 219A, DVTEP-1=VTEP-E1 121 on first EDGE1 111). Second tunnel 102 may be established between (SVTEP-2=VTEP-A 219A, DVTEP-2=VTEP-E2 122 on second EDGE2 112). Third tunnel 103 may be established between (SVTEP-3=VTEP-A 219A, DVTEP-3=VTEP-E3 123 on third EDGE3 113). VTEPs 219A, 121-123 may be associated with the same logical overlay network (e.g., Overlay Net-1). VTEPs, like any other interface, require an IP address and a MAC address. Any suitable IP/MAC address may be configured for VTEPs 219A, 121-123 to facilitate logical overlay network traffic exiting. See tunnel information 510, 511-513 maintained by host-A 210A and/or management entity 270.

In practice, EDGE cluster 110 with M=3 nodes in FIG. 5 may be configured to operate in an active-active mode to provide stateful services. Using the active-active mode, traffic from hosts 210A-B may be distributed to one of EDGE nodes 111-113 to improve throughput performance, resiliency towards failure and scalability. Any suitable approach may be implemented by EDGE cluster 110 to operate in the active-active mode to provide stateful services in SDN environment 100. Various examples are N507.02), U.S. Pat. No. 9,866,473 Attorney Docket No. (N159.03) and U.S. Pat. No. 10,320,665 (Attorney Docket No. N346), which are incorporated herein by reference.

Each EDGE node may be located at the same geographical site as host-A 210A, or a different site. In practice, multiple EDGE nodes may be deployed at different sites for failover and disaster recovery purposes. For example, one or more service providers may be selected for site A. When there is a failure affecting external connectivity at site A, EDGE node(s) at site B may be selected as an exit point for VMs located at site A. Using examples of the present disclosure, traffic may be spread across multiple EDGE nodes that are deployed at different sites and operate in an active-active mode. Depending on the desired implementation, various constraints may be considered when deploying a cluster of EDGE nodes across multiple sites, such as security, return traffic, hairpinning traffic, etc.

(b) Monitoring Sessions

At 420-425 in FIG. 4, host-A 210A may establish a monitoring session with each EDGE node 111/112/113 to monitor logical overlay tunnel 101/102/103 according to a full-mesh topology. Any protocol suitable for monitoring logical overlay tunnels 101-103 may be used, such as Bidirectional Forwarding Detection (BFD), etc. In general, BFD provides a low-overhead, short-duration detection of forwarding path failures. BFD is described in the Internet Engineering Task Force (IETF) Request for Comments (RFC) 5880, etc. Using extensions described in IETF Internet-Drafts entitled “Extended Bidirectional Forwarding Detection” and “BFD Performance Measurement,” BFD may be implemented to measure tunnel state information, such as packet loss, latency, etc. The aforementioned IETF documents are incorporated herein by reference.

Using BFD as an example in FIG. 5, monitoring agent 218A on host-A 210A may interact with first agent 131 on EDGE1 111 to establish a first BFD session between (VTEP-A 219A, VTEP-E1 121) to monitor first tunnel 101. A second BFD session may be established between (VTEP-A 219A, VTEP-E2 122) to monitor second tunnel 102 using monitoring agent 218A and second agent 132 on EDGE2 112. A third BFD session may be established between (VTEP-A 219A, VTEP-E3 123) to monitor third tunnel 103 using monitoring agent 218A and third agent 133 on EDGE3 113. Using an asynchronous mode, for example, BFD probe packets may be sent over a BFD session periodically to measure tunnel state information as follows.

(c) Tunnel State Information

At 430 in FIG. 4, host-A 210A may generate and send probe packets over respective logical overlay tunnels 101-103 to measure tunnel state information. Probe packets 521-523 may be sent by source agent 218A to target agent 131/132/133 to check and monitor the status of VTEP connectivity at layer-2 and layer-3 of the OSI model. Using BFD as an example, BFD performance measurement may be achieved using a BFD performance type-length-value (TLV) in a BFD control frame.

In the example in FIG. 5, a first probe packet (see “X1” 521) specifying (SIP=IP-VTEP-A, DIP=IP-VTEP-E1) may be generated and sent from source VTEP-A 219A towards destination VTEP-E1 121 on EDGE1 111. A second probe packet (see “X2” 522) specifying (SIP=IP-VTEP-A, DIP=IP-VTEP-E2) may be generated and sent towards destination VTEP-E2 122 on EDGE2 112. A third probe packet (see “X3” 523) specifying (SIP=IP-VTEP-A, DIP=IP-VTEP-E2) may be generated and sent towards destination VTEP-E3 123 on EDGE3 113.

Any suitable tunnel state information (denoted as STATE-i for TUN-i) may be measured or generated in real time based on probe packets 521-523. For example, tunnel state information may include at least one of the following metrics: connectivity status (e.g., UP or DOWN), packet latency or delay, packet loss, jitter, etc. In practice, one-way latency is the time required to transmit a packet from a source to a destination. For two-way latency, the round-trip time (RTT) is the time required to transmit a packet from the source to the destination, then back to the source. Packet loss may refer generally to the number of packets lost per a fixed number (e.g., 100) sent. In this case, block 430 may involve host-A 210A tagging each probe packet with a monotonically increasing index or sequence number for packet loss detection. Jitter may refer generally to a variance in latency over time. As network characteristics vary, the tunnel state information measured for a particular tunnel also changes in real time.

At 435 in FIG. 4, a one-way mode may involve target agent 131/132/133 generating tunnel state information and reporting to SDN controller 270. In this case, the tunnel state information may include at least one of the following performance metrics: one-way latency from host-A 210A to EDGE node 111/112/113, jitter, packet loss, connectivity status, etc. The one-way latency may be calculated to be the time difference between (a) a sent timestamp of a probe packet at host-A 210A and (b) a received timestamp of the probe packet at EDGE node 111/112/113. If no probe packet is received within a predetermined period of time, target agent 131/132/133 may update a connectivity status from UP to DOWN for tunnel 101/102/103.

Alternatively or additionally, at 445-450 in FIG. 4, a two-way mode may involve target agent 131/132/133 generating and sending a reply packet to source agent 218A. Based on reply packets triggered by corresponding probe packets, source agent 218A may generate tunnel state information and report to SDN controller 270. In this case, the tunnel state information may include two-way latency, jitter, packet loss, connectivity status, etc. The two-way latency (i.e., RTT) may be the time difference between (a) a sent timestamp of a probe packet and (b) a received timestamp of an associated reply packet at host-A 210A. If no reply packet is received via tunnel 101/102/103 within a predetermined period of time, source agent 218A may update a connectivity status from UP to DOWN for that tunnel.

In the example in FIG. 5, EDGE nodes 111-113 may generate and send respective reply packets 531-533 to host-A 210A. A first reply packet (see “Y1” 531) specifying (SIP=IP-VTEP-E1, DIP=IP-VTEP-A) may be generated and sent from source VTEP-E1 121 on EDGE1 111 towards destination VTEP-A 219A. A second reply packet (see “Y2” 532) specifying (SIP=IP-VTEP-E2, DIP=IP-VTEP-A) may be generated and sent from VTEP-E2 122 on EDGE2 112. A third reply packet (see “Y3” 533) specifying (SIP=IP-VTEP-E2, DIP=IP-VTEP-A) may be generated and sent from VTEP-E3 123 on EDGE3 113.

Based on reply packets 531-533, monitoring agent 218A on host-A 210A may generate tunnel state information (denoted as STATE-i) for each tunnel (TUN-i). For example in FIG. 5, host-A 210A may generate tunnel state information that includes two-way latency (t) for each tunnel. In particular, STATE-1 includes t=5 ms (see 541) for first tunnel 101, STATE-2 includes t=11 ms (see 542) for second tunnel 102 and STATE-3 includes t=6 ms (see 543) for third tunnel 103. Tunnel state information 541-543 may be reported to the control plane using any suitable approach, such as by storing in central datastore 501 accessible by SDN controller 270. Additionally or alternatively, EDGE node 111/112/113 may also report tunnel state information to the control plane (see 544).

(d) Routing Information Configuration

At 455-460 in FIG. 4, SDN controller 270 may compare (a) tunnel state information (STATE-i for i=1, . . . , N) from host-A 210A and/or EDGE node 111/112/113 with (b) a desired state (denoted as DSTATE). Next, at 465-470, based on the comparison, SDN controller 270 may perform routing decisions and instruct host-A 210A to configure routing information associated with a destination network (e.g., network C) in which destination 104 is located. This way, the control plane may manage VTEP connectivity based on the underlying network characteristics, not just path availability (i.e., true/false).

In practice, the desired state may be configured using any suitable approach, such as based on SLA(s), etc. In general, an SLA is a contract between a data center service provider and a service customer to identify service(s) supported by the service provider, performance metric(s) for each service, target performance threshold for each metric, etc. For example, SDN manager 272 on the management plane may provide a user interface to create a service profile based on network objects and apply an SLA profile to the service profile. Example network objects may include layer-3 objects (e.g., IP addresses, IP address groups, prefixes) and layer-4 objects (e.g., TCP/UDP ports). In a first example, an SLA profile may be configured to select all possible paths with latency under a maximum latency (t-max). If no path satisfies this requirement, the “best” path may be selected and a notification is sent to a network administrator. In another example, an SLA profile may be configured to select the path with the lowest latency, or the path with the lowest combination of jitter and packet loss for voice over IP (VoIP) packets.

In the example in FIG. 5, SLA profile information may be stored in a datastore (see 502) managed by SDN manager 272 on the management plane. Using latency as an example, the desired state (DSTATE) may include a maximum latency (t-max) of 10 ms that is derived or extracted from SLA(s). SDN controller 270 may retrieve the desired state from SDN manager 272 to perform a comparison with the tunnel state information measured by host-A 210A and/or EDGE nodes 111-113 in real time. SDN controller 270 may then generate and send control information to instruct host-A 210A to configure routing information based on the comparison. See 550-560 in FIG. 5.

At 475 in FIG. 4, in response to receiving control information from SDN controller 270, host-A 210A may configure routing information associated with a destination network where remote destination 104 is located. The routing information may be configured to include, for each tunnel (TUN-i), an indication as to whether the tunnel state information (STATE-i) satisfies the desired state (DSTATE) derived from SLA(s). This way, during traffic forwarding, a subset of tunnel(s) satisfying the desired state will be considered for selection.

Dynamic Tunnel Selection

At 480-485 in FIG. 4, in response to detecting an egress packet that is destined for remote destination 104, host-A 210A may select one of logical overlay tunnels 101-103 based on the routing information configured at block 475. This way, at 490-495, host-A 210A may generate and send an encapsulated packet over the selected tunnel to reach remote destination 104. Since tunnel state information measured using probe and/or reply packets changes over time, the routing information may adapt to varying network characteristics to facilitate dynamic tunnel selection.

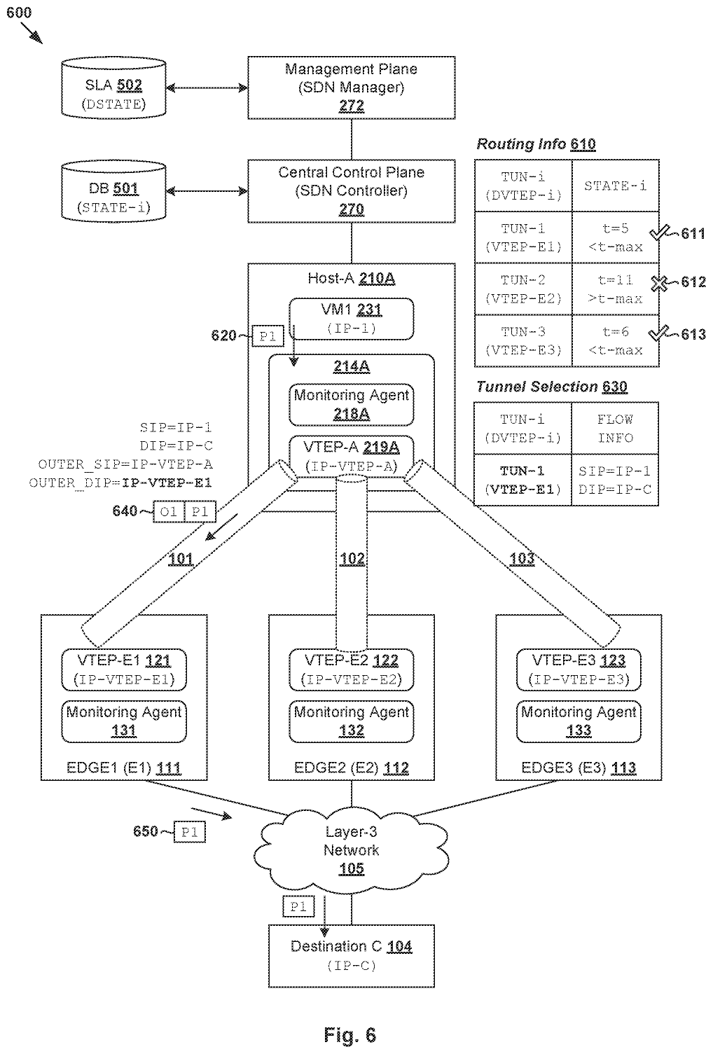

Some examples will now be discussed using FIG. 6, which is a schematic diagram illustrating example 600 of logical overlay tunnel selection for the example in FIG. 5. Using latency as example tunnel state information (STATE-i) in FIG. 6, routing information 610 may indicate whether the desired state (DSTATE) is satisfied for each tunnel (TUN-i).

At 611 in FIG. 6, the desired state is satisfied for first tunnel 101 because its measured latency (t=5 ms) does not exceed the maximum latency (t-max=10 ms), thereby satisfying the desired state. At 613, this is also true for third tunnel 103 having measured latency (t=6 ms). In contrast, at 612 in FIG. 6, routing information 610 indicates that the desired state is not satisfied for second tunnel 102 with EDGE2 112 because its measured latency (t=11 ms) exceeds t-max=10 ms. In practice, since second tunnel 102 does not satisfy the desired state, host-A 210A may configure routing information 610 to include entries for respective first tunnel 101 and third tunnel 103 but exclude second tunnel 102.

At 620 in FIG. 6, in response to detecting egress inner packet (see “P1”) from VM1 231, host-A 210A may retrieve routing information 610 associated with a destination network in which remote destination 104 is located. Based on routing information 611/613, host-A 210A may include first tunnel 101 and third tunnel 103 as candidates for selection. Based on routing information 612 (i.e., DSTATE not satisfied), second tunnel 102 may be excluded from the selection. Any suitable approach may be used to select either first tunnel 101 or third tunnel 103, such as based on the lowest latency (i.e., first tunnel 101), round robin, hash value calculated using packet header information, etc.

At 630 in FIG. 6, host-A 210A may select first tunnel 101 to reach remote destination 104. In practice, host-A 210A may keep track of the selection by storing mapping information associating first tunnel 101 (see TUN-1) with packet flow information (SIP=IP-1, DIP=IP-C) extracted from egress packet. Although not shown for simplicity in FIG. 6, any other packet flow information may be recorded, such as MAC address information, layer-4 information (e.g., port number, protocol), etc.

At 640 in FIG. 6, an encapsulated packet may be generated and sent towards EDGE1 111 over first tunnel 101 to reach destination 104. This may involve encapsulating the egress packet (P1) with an outer header (O1). The egress packet specifies inner address information (SIP=IP-1, DIP=IP-C) associated with source VM1 231 and destination 104. The outer header specifies outer address information (OUTER_SIP=IP-VTEP-A, OUTER_DIP=IP-VTEP-E1) associated with source VTEP-A 219A and destination VTEP-E1 121 on EDGE1 111.

At 650 in FIG. 6, in response to receiving the encapsulated packet, EDGE1 111 may perform decapsulation to remove the outer header (O1) and process the egress packet (P1) according to any suitable networking service(s). Example networking services implemented by EDGE 111/112/113 may include DNS forwarding, DHCP, SNAT, DNAT, deep packet inspection, etc. The processed packet (P1) is then forwarded towards layer-3 network 105 and destination 104, such as via a NIC interface associated with IP address=IP-Net-Transit1 on EDGE1 111. Acting as a gateway, EDGE1 111 may be considered to be an exit point to reach a destination outside of an overlay network. See blocks 496-498 in FIG. 4.

Performance Degradation

Using examples of the present disclosure, logical overlay tunnel selection may be updated dynamically according to real-time tunnel state information. An example will be discussed using FIG. 7, which is a schematic diagram illustrating example 700 of logical overlay tunnel selection in the event of performance degradation for the example in FIG. 5.

At 710 in FIG. 7, first tunnel 101 may suffer from performance degradation for various reasons, such as traffic congestion, hardware failure (e.g., at EDGE1 111 or intermediate switch), software failure, malicious attack, invalid configuration, reboot, a combination thereof, etc. The performance degradation may be detected in real time using probe and/or reply packets (not shown), particularly based on tunnel state information 711-714 reported by host-A 210A and/or EDGE 111/112/113.

At 720 in FIG. 7, based on tunnel state information 711-714, SDN controller 270 may generate and send control information to instruct host-A 210A to update or reconfigure routing information associated with a destination network in which destination 104 is located. For example, updated routing information 730 may indicate that first tunnel 101 no longer satisfies the desired state (e.g., t=20 ms exceeds t-max). Based on the real-time tunnel state information, both second tunnel 102 and third tunnel 103 satisfy the desired state (t-max not exceeded). As such, host-A 210A may reconfigure routing information 730 to include second tunnel 102 and third tunnel 103 but exclude first tunnel 101. See 731-733 in FIG. 7.

At 740-750 in FIG. 7, in response to detecting a subsequent egress packet (see “P2”) from VM1 231 to destination 104, host-A 210A may switch from first tunnel 101 to either second tunnel 102 or third tunnel 103. Selecting second tunnel 102 as an example, host-A 210A may update the mapping information associating packet flow information (SIP=IP-1, DIP=IP-C) with second tunnel 102 (see TUN-2) instead of first tunnel 101 shown in FIG. 6.

At 760 in FIG. 7, an encapsulated packet may be generated and sent towards EDGE2 112 over second tunnel 102 to reach destination 104. This has the effect of redirecting overlay network traffic from first tunnel 101 to second tunnel 102. The encapsulated packet may be generated by encapsulating the egress packet (P2) with an outer header (O2). The egress packet specifies (SIP=IP-1, DIP=IP-C) associated with source VM1 231 and destination 104. The outer header specifies (OUTER_SIP=IP-VTEP-A, OUTER_DIP=IP-VTEP-E2) associated with source VTEP-A 219A and destination VTEP-E2 122 on EDGE2 112.

At 770 in FIG. 7, in response to receiving the encapsulated packet, EDGE2 112 may perform decapsulation to remove the outer header (O2) and process the egress packet (P2) according to any suitable networking service(s). The processed packet (P2) is then forwarded towards destination 104 via layer-3 network 105.

In practice, any suitable approach may be used to resolve issues relating to out-of-order delivery using multiple tunnels, such as stream control transmission protocol (SCTP) that provides sequenced delivery of user messages within multiple streams, with an option for order-of-arrival delivery of individual messages. SCTP is standardized by the IETF in RFC 4960 and incorporated herein by reference.

Multiple VTEP Configuration

Examples of the present disclosure may be implemented by host-A 210A with multiple VTEPs. Some examples will be described using FIG. 8, which is a schematic diagram illustrating an example of logical overlay tunnel selection for a first computer system with multiple VTEPs. EDGE3 113 is not shown in FIG. 8 for simplicity.

In the example in FIG. 8, host-A 210A and EDGE nodes 111-112 are each configured with two VTEPs, each VTEP having a 1:1 binding with a PNIC. In particular, VTEP-A1 801 and VTEP-A2 802 at host-A 210A have a 1:1 binding with respective PNIC-A1 803 and PNIC-A2 804. At EDGE1 111, VTEP-10 810 and VTEP-11 811 have a 1:1 binding with respective PNIC-10 812 and PNIC-11 813. At EDGE2 112, VTEP-20 820 and VTEP-21 821 have a 1:1 binding with respective PNIC-20 822 and PNIC-21 823. Although not shown in FIG. 8, each VNIC of VM1 231 may be associated with a single VTEP on host-A 210A.

According to the example in FIG. 4, N=8 logical overlay tunnels and BFD monitoring sessions may be established among the VTEPs according to a full-mesh topology. Using source VTEP-A1 801 on host-A 210A, a first tunnel may be established with VTEP-10 810 (see 831), a second tunnel with VTEP-11 811 (see 832), a third tunnel with VTEP-20 820 (see 833) and a fourth tunnel with VTEP-21 821 (see 834). Using source VTEP-A2 802 on host-A 210A, four additional tunnels may be established with respective VTEP-10 810 (see 835), VTEP-11 811 (see 836), VTEP-20 820 (see 837) and VTEP-21 821 (see 838).

At 840 in FIG. 8, probe packets (denoted as Xi for TUN-i) may be generated and sent towards EDGE1 111 and EDGE2 112 to monitor the logical overlay tunnels. Using a two-way mode, EDGE 111/112 may respond with reply packets (not shown for simplicity). This way, at 850-851, host-A 210A and/or EDGE 111/112 may measure and report tunnel state information (STATE-i) to the control plane. For example, the measured tunnel state information may include packet loss and jitter. In this case, at 860, the desired state derived from SLA(s) may include a maximum threshold for packet loss (l-max) and a maximum threshold for jitter (j-max).

At 870-880 in FIG. 8, based on control information from SDN controller 270, host-A 210A may configure routing information associated with a destination network in which destination 104 is located. Routing information 880 may be configured based on a comparison between (a) tunnel state information measured in real time and (b) a desired state (DSTATE) derivable from SLA(s). In this example, routing information 880 may be configured to include four tunnels 831-834 (see TUN-1 to TUN-4) that satisfy the desired state. The remaining tunnels 835-838 (see TUN-5 to TUN-8) do not satisfy the desired state and are excluded from subsequent selection.

At 890-891 in FIG. 8, in response to detecting an egress packet (P3) from VM1 231 to remote destination 104, host-A 210A may select a tunnel from candidate tunnels 831-834 (see TUN-1 to TUN-4) in routing information 880. For example, TUN-1 (see 881) may be selected based on its lowest combination of packet loss and jitter. In this case, host-A 210A may generate and send an encapsulated packet over TUN-1 from source VTEP-A1 801 to destination VTEP-10 810 on EDGE1 111. The encapsulated packet includes the egress packet (P3) and an outer header specifying (OUTER_SIP=IP-VTEP-A1, OUTER_DIP=IP-VTEP-10).

At EDGE1 111, any suitable processing may be performed before the egress packet (P3) is forwarded towards destination 104. Note that routing information 880 may be reconfigured over time based on tunnel state information measured in real time. In the event of performance degradation, the selected tunnel 831 (see TUN-1) may be excluded from routing information 880 and a different tunnel may be selected for subsequent packets. Reconfiguration of routing information has been described using FIG. 7 and will not be repeated here for brevity.

Container Implementation

Although discussed using VMs 231-234, it should be understood that logical overlay tunnel selection may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 231, where a different VNIC is configured for each container. Each container is “OS-less”, meaning that it does not include any OS that could weigh 11 s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 8. For example, a computer system capable of acting as host 210A/210B or EDGE 111/112/113 may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

We claim:

1. A method for a first computer system to perform logical overlay tunnel selection, wherein the method comprises:
generating and sending probe packets over multiple logical overlay tunnels via which a destination is reachable from the first computer system;
configuring routing information associated with the destination based on a comparison between tunnel state information measured using the probe packets and a desired state; and
in response to detecting, from a virtualized computing instance on the first computer system, an egress packet that is destined for the destination,
based on the routing information, selecting a first logical overlay tunnel that satisfies the desired state over a second logical overlay tunnel that does not satisfy the desired state, wherein the first logical overlay tunnel is established between a first virtual tunnel endpoint (VTEP) on the first computer system and a second VTEP on a second computer system; and
generating and sending an encapsulated packet over the first logical overlay tunnel towards the second computer system to reach the destination, wherein the encapsulated packet includes the egress packet and an outer header that is addressed from the first VTEP and the second VTEP.

2. The method of claim 1, wherein configuring the routing information comprises:
configuring the routing information based on control information received from a management entity that is capable of at least one of the following: (a) identifying the desired state based on one or more service level agreements and (b) performing the comparison between the tunnel state information measured and the desired state.

3. The method of claim 1, wherein the method further comprises:
based on performance degradation detected using subsequent probe packets, reconfiguring the routing information to indicate that the first logical overlay tunnel no longer satisfies the desired state.

4. The method of claim 3, wherein the method further comprises:
in response to detecting a subsequent egress packet from the virtualized computing instance to the destination, switching from the first logical overlay tunnel to the second logical overlay tunnel or a third logical overlay tunnel that satisfies the desired state.

5. The method of claim 1, wherein generating and sending the probe packets comprises:
generating and sending the probe packets over the multiple logical overlay tunnels to cause multiple second computer systems to respond with reply packets; and
based on the reply packets, generating the tunnel state information that measures at least one of the following: two-way latency, jitter, packet loss and connectivity status.

6. The method of claim 1, wherein generating and sending the probe packets comprises:
generating and sending the probe packets the probe packets over the multiple logical overlay tunnels to cause multiple second computer systems to generate the tunnel state information that measures at least one of the following: one-way latency, jitter, packet loss and connectivity status.

7. The method of claim 1, wherein the method comprises:
prior to generating and sending the probe packets, establishing multiple monitoring sessions multiple second computer systems in the form of a cluster of edge nodes operating in an active-active mode to provide one or more networking services for the first computer system.

8. A non-transitory computer-readable storage medium that includes a set of instructions which, in response to execution by a processor of a first computer system, cause the processor to perform a method of logical overlay tunnel selection, wherein the method comprises:
generating and sending probe packets over multiple logical overlay tunnels via which a destination is reachable from the first computer system;
configuring routing information associated with the destination based on a comparison between tunnel state information measured using the probe packets and a desired state; and
in response to detecting, from a virtualized computing instance on the first computer system, an egress packet that is destined for the destination,
based on the routing information, selecting a first logical overlay tunnel that satisfies the desired state over a second logical overlay tunnel that does not satisfy the desired state, wherein the first logical overlay tunnel is established between a first virtual tunnel endpoint (VTEP) on the first computer system and a second VTEP on a second computer system; and
generating and sending an encapsulated packet over the first logical overlay tunnel towards the second computer system to reach the destination, wherein the encapsulated packet includes the egress packet and an outer header that is addressed from the first VTEP and the second VTEP.

9. The non-transitory computer-readable storage medium of claim 8, wherein configuring the routing information comprises:
configuring the routing information based on control information received from a management entity that is capable of at least one of the following: (a) identifying the desired state based on one or more service level agreements and (b) performing the comparison between the tunnel state information measured and the desired state.

10. The non-transitory computer-readable storage medium of claim 8, wherein the method further comprises:
based on performance degradation detected using subsequent probe packets, reconfiguring the routing information to indicate that the first logical overlay tunnel no longer satisfies the desired state.

11. The non-transitory computer-readable storage medium of claim 10, wherein the method further comprises:
in response to detecting a subsequent egress packet from the virtualized computing instance to the destination, switching from the first logical overlay tunnel to the second logical overlay tunnel or a third logical overlay tunnel that satisfies the desired state.

12. The non-transitory computer-readable storage medium of claim 8, wherein generating and sending the probe packets comprises:
generating and sending the probe packets over the multiple logical overlay tunnels to cause multiple second computer systems to respond with reply packets; and
based on the reply packets, generating the tunnel state information that measures at least one of the following: two-way latency, jitter, packet loss and connectivity status.

13. The non-transitory computer-readable storage medium of claim 8, wherein generating and sending the probe packets comprises:
generating and sending the probe packets the probe packets over the multiple logical overlay tunnels to cause multiple second computer systems to generate the tunnel state information that measures at least one of the following: one-way latency, jitter, packet loss and connectivity status.

14. The non-transitory computer-readable storage medium of claim 8, wherein the method comprises:
prior to generating and sending the probe packets, establishing multiple monitoring sessions multiple second computer systems in the form of a cluster of edge nodes operating in an active-active mode to provide one or more networking services for the first computer system.

15. A computer system, being a first computer system, configured to perform logical overlay tunnel selection, wherein the computer system comprises:
a processor; and
a non-transitory computer-readable medium having stored thereon instructions that, when executed by the processor, cause the processor to:
generate and send probe packets over multiple logical overlay tunnels via which a destination is reachable from the first computer system;
configure routing information associated with the destination based on a comparison between tunnel state information measured using the probe packets and a desired state; and
in response to detecting, from a virtualized computing instance on the first computer system, an egress packet that is destined for the destination,
based on the routing information, select a first logical overlay tunnel that satisfies the desired state over a second logical overlay tunnel that does not satisfy the desired state, wherein the first logical overlay tunnel is established between a first virtual tunnel endpoint (VTEP) on the first computer system and a second VTEP on a second computer system; and
generate and send an encapsulated packet over the first logical overlay tunnel towards the second computer system to reach the destination, wherein the encapsulated packet includes the egress packet and an outer header that is addressed from the first VTEP and the second VTEP.

16. The computer system of claim 15, wherein the instructions for configuring the routing information cause the processor to:
configure the routing information based on control information received from a management entity that is capable of at least one of the following: (a) identifying the desired state based on one or more service level agreements and (b) performing the comparison between the tunnel state information measured and the desired state.

17. The computer system of claim 15, wherein the instructions further cause the processor to:
based on performance degradation detected using subsequent probe packets, reconfiguring the routing information to indicate that the first logical overlay tunnel no longer satisfies the desired state.

18. The computer system of claim 17, wherein the instructions further cause the processor to:
in response to detecting a subsequent egress packet from the virtualized computing instance to the destination, switching from the first logical overlay tunnel to the second logical overlay tunnel or a third logical overlay tunnel that satisfies the desired state.

19. The first computer system of claim 15, wherein the instructions for generating and sending the probe packets cause the processor to:
generating and sending the probe packets over the multiple logical overlay tunnels to cause multiple second computer systems to respond with reply packets; and
based on the reply packets, generating the tunnel state information that measures at least one of the following: two-way latency, jitter, packet loss and connectivity status.

20. The first computer system of claim 15, wherein the instructions for generating and sending the probe packets cause the processor to:
generating and sending the probe packets the probe packets over the multiple logical overlay tunnels to cause multiple second computer systems to generate the tunnel state information that measures at least one of the following: one-way latency, jitter, packet loss and connectivity status.

21. The computer system of claim 15, wherein the instructions further cause the processor to:
prior to generating and sending the probe packets, establish multiple monitoring sessions multiple second computer systems in the form of a cluster of edge nodes operating in an active-active mode to provide one or more networking services for the first computer system.
